(19) United States
(12) Patent Application Publication
(10) Pub. No.: US 2013/0267130 A1
(43) Pub. Date: Oct. 10, 2013

(54) NEUTRAL BAR INCLUDING FASTENERS HAVING A ROUNDED END WITH A HEMISPHERICAL SURFACE

(71) Applicants: DAVID R. SOMMER, BLOOMINGTON, IL (US); TONY R. BENSON, WHITE HEATH, IL (US)

(72) Inventors: DAVID R. SOMMER, BLOOMINGTON, IL (US); TONY R. BENSON, WHITE HEATH, IL (US)

(21) Appl. No.: 13/439,085

(22) Filed: Apr. 4, 2012

(51) Int. Cl. H01R 4/36

(52) U.S. Cl. 439/810

(57) ABSTRACT

A neutral bar includes a plurality of neutral bar fasteners, each of the neutral bar fasteners has a first end, a rounded second end with a hemispherical surface opposite the first end, and a threaded shaft therebetween. An elongated, generally rectangular member includes a plurality of tapped openings and a plurality of cylindrical openings. Each of the cylindrical openings is normal to a corresponding one of the tapped openings. The threaded shaft of each of the neutral bar fasteners is threaded into a corresponding one of the tapped openings of the elongated, generally rectangular member. Each of the cylindrical openings is structured to receive a stranded conductor having a plurality of individual solid conductors. The hemispherical surface of each of the neutral bar fasteners is structured to engage the stranded conductor within a corresponding one of the cylindrical openings.

### BACKGROUND

1. Field

The disclosed concept pertains generally to neutral bars and, more particularly, to such neutral bars for stranded conductors.

2. Background Information

It is known to employ a neutral bar to provide a common point for termination of a plurality of neutral conductors and one ground conductor in a panelboard or load center. Each of a plurality of screw terminals electrically and mechanically engages one end of a corresponding neutral or ground conductor.

FIG. 1 shows a neutral bar screw 2 having a flat end 4. It is believed that known neutral bar screws of neutral bars for panelboards or load centers employ such a flat end.

Certain known neutral bars do not pass a UL486A-486B current cycling test for a 75° C. rating when using a #4 AWG stranded aluminum conductor. For example, the neutral bar screw breaks one or two strands of the #4 AWG stranded aluminum conductor at rated 35 lb-in. torque.

A glowing contact is a high resistance electrical connection, which can form, for example and without limitation, at the interface of a conductor (e.g., wire) and a screw terminal (e.g., line terminal; neutral terminal; ground terminal), for example, of a receptacle or a neutral bar. A glowing contact is known to produce substantial heat. It is very easy to create a high resistance or glowing contact at a screw terminal using copper wire. The hazards associated with glowing contacts, including contacts made with all combinations of copper, brass and iron are known. See, for example, U.S. Pat. Nos. 6,948,846; and 6,707,652.

There is room for improvement in neutral bars.

### SUMMARY

These needs and others are met by embodiments of the disclosed concept in which a neutral bar includes a plurality of neutral bar fasteners, each of the neutral bar fasteners comprising a first end, a rounded second end having a hemispherical surface opposite the first end, and a threaded shaft therebetween.

In accordance with an aspect of the disclosed concept, a neutral bar comprises: a plurality of neutral bar fasteners, each of the neutral bar fasteners comprising a first end, a rounded second end having a hemispherical surface opposite the first end, and a threaded shaft therebetween; and an elongated, generally rectangular member comprising a plurality of tapped openings and a plurality of cylindrical openings, each of the cylindrical openings being normal to a corresponding one of the tapped openings, wherein the threaded shaft of each of the neutral bar fasteners is threaded into a corresponding one of the tapped openings of the elongated, generally rectangular member, wherein each of the cylindrical openings is structured to receive a stranded conductor having a plurality of individual solid conductors, and wherein the hemispherical surface of each of the neutral bar fasteners is structured to engage the stranded conductor within a corresponding one of the cylindrical openings.

In accordance with another aspect of the disclosed concept, a neutral bar comprises: a plurality of neutral bar fasteners, each of the neutral bar fasteners comprising a first end, a rounded second end having a hemispherical surface opposite the first end, and a threaded shaft therebetween; and an elongated, generally rectangular member comprising a plurality of tapped openings and a plurality of cylindrical openings, each of the cylindrical openings being normal to a corresponding one of the tapped openings, wherein the threaded shaft of each of the neutral bar fasteners is threaded into a corresponding one of the tapped openings of the elongated, generally rectangular member, wherein each of the cylindrical openings is structured to receive a number of conductors, and wherein the hemispherical surface of each of the neutral bar fasteners is structured to engage the number of conductors within a corresponding one of the cylindrical openings.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of a neutral bar screw having a flat end.

FIG. 2 is an isometric view of a neutral bar screw having a rounded end with a hemispherical surface in accordance with embodiments of the disclosed concept.

FIG. 3 is a vertical elevation view of the neutral bar screw of FIG. 2.

FIG. 4 is a top plan view of the neutral bar screw of FIG. 2.

FIG. 5 is another vertical elevation view of a portion of the neutral bar screw of FIG. 2.

FIG. 6 is an isometric view of a neutral bar including a plurality of the neutral bar screws of FIG. 2.

FIG. 7 is a vertical elevation view of a portion of the neutral bar of FIG. 6 including a first surface corresponding to the rounded end of the neutral bar screw and a second surface of a cylindrical opening receiving a stranded conductor.

FIG. 8 is an isometric view of two different hemispherical surfaces.

### DESCRIPTION OF THE PREFERRED EMBODIMENTS

As employed herein, the term “number” shall mean one or an integer greater than one (i.e., a plurality).

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

As employed herein, the term “hemisphere” shall mean one of two half spheres formed by a plane through a sphere's center.

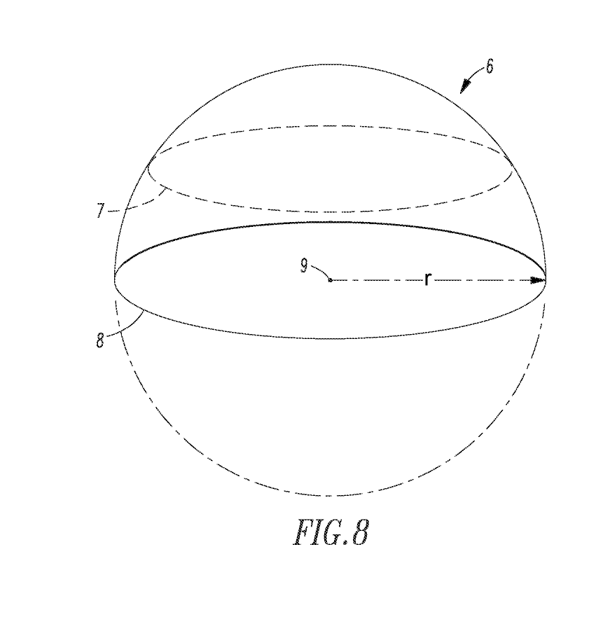

As employed herein, the term “hemispherical surface” shall mean all of the external surface of a hemisphere (e.g., without limitation, as shown as 6 in FIG. 8) or a smaller portion of the external surface of such hemisphere as limited by a plane (e.g., without limitation, 7) parallel to a plane (e.g., without limitation, 8) through the corresponding sphere's center (e.g., without limitation, 9 for a sphere of radius r). For example and without limitation, as applied to the Earth's surface, all of the surface of a hemisphere could be all of the surface of the Northern Hemisphere or all of the surface of the Southern Hemisphere, and a smaller portion of the surface of such hemisphere could be all of the surface of the Northern Hemisphere or all of the surface of the Southern Hemisphere but excluding the surface between the Equator and 10 degrees North latitude or 10 degrees South latitude, respectively.

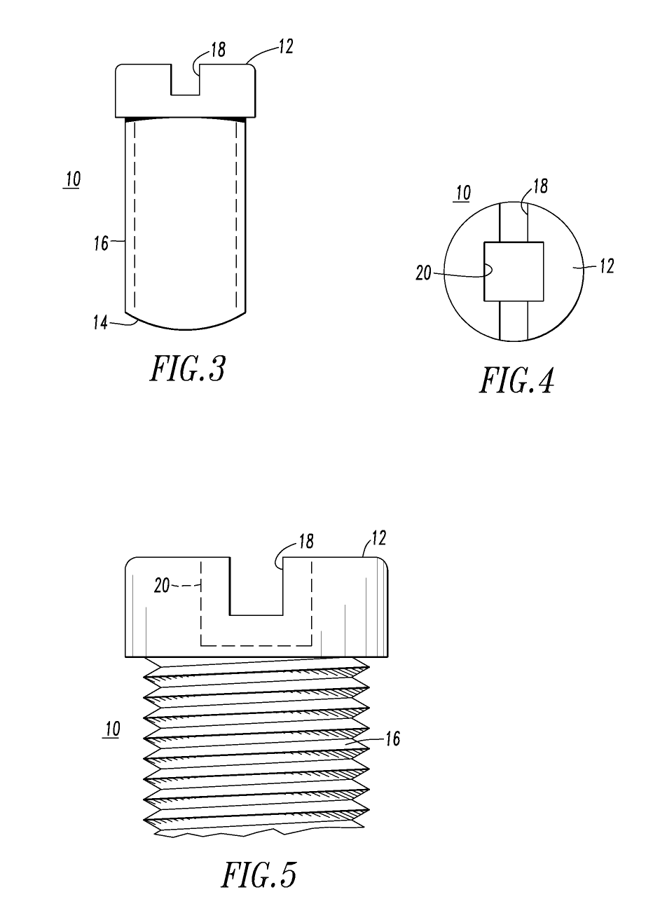

Referring to FIGS. 2-5, a neutral bar fastener, such as the example neutral bar screw 10 is shown. The example neutral bar screw 10 includes a first end 12, a rounded second end 14 opposite the first end 12, and a threaded shaft 16 therebetween. The example rounded end 14 is in the form of a hemispherical surface as defined herein. The example first end 12 is in the form of a round flat head having a slot 18 and a square recess 20, although any suitable end compatible with any suitable driving member(s) can be employed.

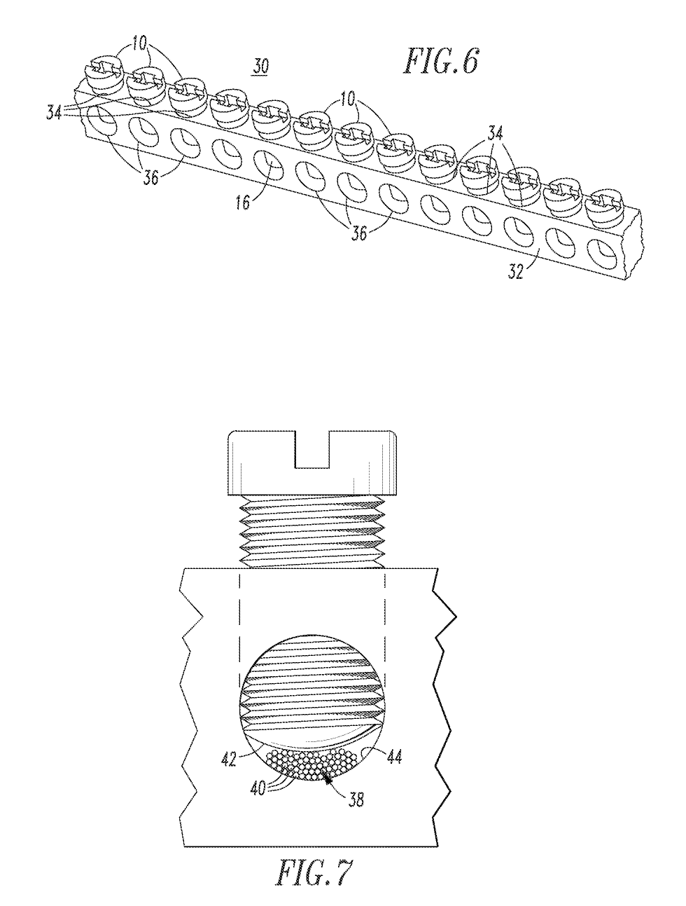

FIGS. 6 and 7 show a neutral bar 30 including a plurality of the neutral bar screws 10 of FIGS. 2-5. The example neutral bar 30 also includes an elongated, generally rectangular member 32 having a plurality of tapped openings 34 and a plurality of cylindrical openings 36. Each of the cylindrical openings 36 is normal to and partially coextensive with a corresponding one of the tapped openings 34. The threaded shaft 16 of each of the neutral bar screws 10 is threaded into a corresponding one of the tapped openings 34 of the elongated, generally rectangular member 32. Each of the cylindrical openings 36 is structured to receive a stranded conductor 38 (shown in phantom line drawing in FIG. 7) having a plurality of individual solid conductors 40 (shown in cross-section and phantom line drawing in FIG. 7). FIG. 7 shows a first surface 42 corresponding to the rounded end 14 of the neutral bar screw 10 and a second surface 44 of the cylindrical opening 36 receiving the stranded conductor 38. The hemispherical surface of the example rounded end 14 of each of the neutral bar screws 10 is structured to engage the stranded conductor 38 within a corresponding one of the cylindrical openings 36. Any suitable count of two or more tapped openings 34 for a corresponding count of neutral bar screws 10 and cylindrical openings 36 can be employed.

### Example 1

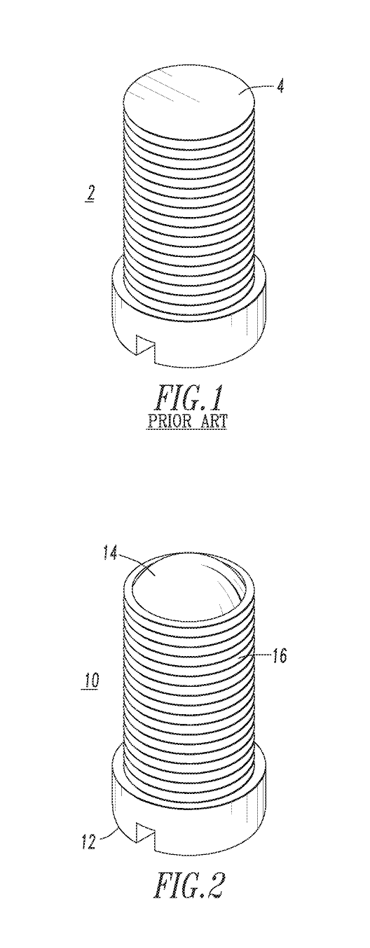

It is believed that the rounded end 14 of the disclosed neutral bar screw 10 works better than the flat end 4 of the flat end screw 2 (FIG. 1) with a stranded conductor, such as 38 (FIG. 7), since the rounded end 14 generally matches the profile of the bottom (with respect to FIG. 7) of the cylindrical opening 36 for the stranded conductor 38. The rounded end 14 allows for better contact between the stranded conductor 38 and the mating body of the neutral bar 30. This better contact allows for improved current flow between the stranded conductor 38 and the mating body of the neutral bar 30. Also, the rounded end 14 allows for improved heat transfer away from the mating body of the neutral bar 30.

### Example 2

Furthermore, a cooler running mating body of the neutral bar 30 is beneficial because it does not damage tin plating applied to the mating body of the neutral bar 30. The example neutral bar screw 10 is made of steel with zinc plating. On aluminum neutral bars, a layer of copper plating is applied before an optional layer of nickel plating and a top layer of tin plating. The copper plating acts as a primer for the tin plating. The tin plating does not stick to directly to the aluminum material. Other suitable neutral bar materials include copper bars with tin plating, copper bars without tin plating for use with copper conductors, and zinc bars with tin plating.

In the example embodiment, the aluminum elongated, generally rectangular member 30 includes a layer of copper plating applied thereto, an optional layer of nickel plating applied to the layer of copper plating, and a layer of tin plating applied to the optional layer of nickel plating or to the copper plating. The layer of copper plating acts as a primer for the layer of tin plating. Although examples of neutral bar and neutral bar screw materials and plating materials are disclosed, any suitable material and/or plating material (or no plating material) can be employed.

When the neutral bar temperatures run relatively hot, copper atoms can move into the tin plating. When the copper and tin atoms intermix, a high resistance alloy is created. This intermixing can cause the mating body of the neutral bar 30 to overheat and fail. Hence, a reliable electrical connection to the stranded conductor 38 (FIG. 7) is needed.

### Example 3

The rounded end 14 of the neutral bar screw 10 does not pinch the outside of the solid conductors (strands) 40 (FIG. 7). Another UL requirement is that neutral bar fasteners cannot break conductor strands. The rounded end 14 more evenly spreads the clamping force of the neutral bar screw 10 over the solid conductors (strands) 40. The hemispherical surface of the rounded end 14 is structured not to break any of the individual solid conductors (strands) 40 of the stranded conductor 38.

Conversely, the prior flat end screw 2 of FIG. 1 presses on a stranded conductor only at the flat end 4. This does not allow for good stranded conductor to neutral bar contact.

### Example 4

In one embodiment, the hemispherical surface of the rounded end 14 of the neutral bar screw 10 has about a 0.188″ radius, although a larger or smaller radius on the neutral bar screw 10 can be employed. Preferably, the neutral bar screw radius that has the smallest gap to the neutral bar, such as 30, is the best radius.

### Example 5

The disclosed concept can be applied to a wide range of conductors (e.g., without limitation, #14, #12, #10, #8, #6 or #4 AWG wires, either solid or stranded, in copper or aluminum except for #14 AWG aluminum wire which is not listed in the UL test standard; a quantity or one, two or three #14, #12 or #10 AWG copper wires, solid or stranded; a quantity of one, two or three #12 or #10 AWG aluminum wires, solid or stranded).

### Example 6

The disclosed concept passes UL 486A-486B connector current cycling tests at a 75° C. rating. This UL Standard applies to single-polarity connectors for use with all alloys of copper or aluminum, or copper-clad aluminum conductors, or all three, for providing contacts between current-carrying parts of neutral bars. With #4 AWG aluminum conductor, UL requires 110 amperes for a 75° C. rating. For a 90° C. rating, the current is 140 amperes. The UL test consists of 500 cycles of 1 hour on/1 hour off current. The disclosed neutral bar screw 10 and neutral bar 30 pass the UL486A-486B current cycling test for a 75° C. rating when using a #4 AWG stranded aluminum conductor. Also, the neutral bar screw 10 does not break any strand of the #4 AWG stranded conductor at rated torque.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof

What is claimed is:

1. A neutral bar comprising:
a plurality of neutral bar fasteners, each of said neutral bar fasteners comprising a first end, a rounded second end having a hemispherical surface opposite the first end, and a threaded shaft therebetween; and
an elongated, generally rectangular member comprising a plurality of tapped openings and a plurality of cylindrical openings, each of the cylindrical openings being normal to a corresponding one of the tapped openings,
wherein the threaded shaft of each of said neutral bar fasteners is threaded into a corresponding one of the tapped openings of said elongated, generally rectangular member,
wherein each of the cylindrical openings is structured to receive a stranded conductor having a plurality of individual solid conductors, and
wherein the hemispherical surface of each of said neutral bar fasteners is structured to engage the stranded conductor within a corresponding one of the cylindrical openings.

2. The neutral bar of claim 1 wherein the neutral bar fasteners are a plurality of neutral bar screws.

3. The neutral bar of claim 1 wherein the plurality of neutral bar fasteners are at least two neutral bar fasteners, the plurality of tapped openings are at least two tapped openings, and the plurality of cylindrical openings are at least two cylindrical openings.

4. The neutral bar of claim 1 wherein the neutral bar fasteners and the elongated, generally rectangular member are tin plated.

5. The neutral bar of claim 1 wherein the elongated, generally rectangular member is made of aluminum.

6. The neutral bar of claim 5 wherein the aluminum elongated, generally rectangular member includes a layer of copper plating applied thereto, and a layer of tin plating applied to the layer of copper plating.

7. The neutral bar of claim 6 wherein the layer of copper plating acts as a primer for the layer of tin plating.

8. The neutral bar of claim 5 wherein the aluminum elongated, generally rectangular member includes a layer of copper plating applied thereto, a layer of nickel plating applied to the layer of copper plating, and a layer of tin plating applied to the layer of nickel plating.

9. The neutral bar of claim 1 wherein the hemispherical surface of the rounded second end of each of said neutral bar fasteners is structured not to break any of the plurality of individual solid conductors of the stranded conductor.

10. The neutral bar of claim 1 wherein the hemispherical surface of the rounded second end has about a 0.188 inch radius.

11. The neutral bar of claim 1 wherein said stranded conductor is a #4 AWG stranded aluminum conductor.

12. A neutral bar comprising:
a plurality of neutral bar fasteners, each of said neutral bar fasteners comprising a first end, a rounded second end having a hemispherical surface opposite the first end, and a threaded shaft therebetween; and
an elongated, generally rectangular member comprising a plurality of tapped openings and a plurality of cylindrical openings, each of the cylindrical openings being normal to a corresponding one of the tapped openings,
wherein the threaded shaft of each of said neutral bar fasteners is threaded into a corresponding one of the tapped openings of said elongated, generally rectangular member,
wherein each of the cylindrical openings is structured to receive a number of conductors, and
wherein the hemispherical surface of each of said neutral bar fasteners is structured to engage said number of conductors within a corresponding one of the cylindrical openings.

13. The neutral bar of claim 12 wherein said number of conductors is selected from the group consisting of a #12 AWG stranded aluminum conductor, a #10 AWG stranded aluminum conductor, a #8 AWG stranded aluminum conductor, a #6 AWG stranded aluminum conductor, a #4 AWG stranded aluminum conductor, a #14 AWG stranded copper conductor, a #12 AWG stranded copper conductor, a #10 AWG stranded copper conductor, a #8 AWG stranded copper conductor, a #6 AWG stranded copper conductor, a #4 AWG stranded copper conductor, two #14 AWG stranded copper conductors, three #14 AWG stranded copper conductors, two #12 AWG stranded copper conductors, three #12 AWG stranded copper conductors, two #10 AWG stranded copper conductors, three #10 AWG stranded copper conductors, two #12 AWG stranded aluminum conductors, three #12 AWG stranded aluminum conductors, two #10 AWG stranded aluminum conductors, and three #10 AWG stranded aluminum conductors.
